(19) United States
(12) Patent Application Publication
(10) Pub. No.: US 2026/0161658 A1
(43) Pub. Date: Jun. 11, 2026

(54) Techniques for Generating Structured Data from Unstructured Data

(71) Applicant: Stripe, Inc., South San Francisco, CA (US)

(72) Inventors: Gautam Kedia, San Mateo, CA (US); Amanpreet Singh, New York, NY (US); Dong Kwak, San Francisco, CA (US); Michelle Hwang, San Francisco, CA (US)

(21) Appl. No.: 18/972,115

(22) Filed: Dec. 6, 2024

(51) Int. Cl. G06F 16/25

(52) U.S. Cl. CPC G06F 16/258

(57) ABSTRACT

This disclosure describes techniques for generating structured data, such as for client system intelligence, based on unstructured data in an efficient, valuable, automated, and intelligent manner. Content may be extracted from unstructured data and then processed and stored in a manner to facilitate correlating the content with a query. For example, content may be embedded into a vector space. When a query is received, the query may similarly be embedded into the vector space in order to identify content that is relevant to the query. A prompt for a machine learning (ML) model (e.g., a large language model (LLM)) may then be automatically generated based on the query and the relevant content. The output of the ML model may then be validated and integrated into various downstream systems and subsystems, such as to recognize client development opportunities.

### FIELD OF DISCLOSURE

This disclosure is related generally to techniques for generating structured data from unstructured data, and more particularly, to utilizing machine learning models to generate structured data from unstructured data.

### BACKGROUND

Structured data includes data that is organized in a pre-defined manner. A data model may be utilized to explicitly determine the structure of data. Thus, structured data is organized according to an explicit data model or data structure. A data model may refer to an abstract model that organizes elements of data and standardizes how they relate to one another and to the properties of real-word entities. For example, a data model may specify that the data element representing a car can be composed of a number of other elements, which, in turn, represent the color and size of the car and define its owner.

Unstructured, on the other hand, data generally refers to information that either does not have a pre-defined data model or is not organized in a pre-defined manner. Unstructured information is typically text-heavy, but may include data such as dates, numbers, and facts. Some examples of unstructured data include videos, images, email messages, websites, as well as other forms of data. The unstructured nature of such data results in irregularities and ambiguities, and therefore make unstructured data difficult to understand using traditional programs, whereas data stored in fielded form in predefined file types, databases, or annotated in documents are easy for programs to understand. Data with some form of structure may still be characterized as unstructured if its structure is not helpful for the processing task at hand. For example, data on a website may have some structure in the arrangement of elements according to a predefined structure, such as an HTML document. However, the structure is oftentimes not helpful for deriving answers to questions based on the content of the website due to the unstructured nature of the content of the website, greatly varying forms between different websites, as well as other configurations of a website that are unique to each website.

With websites, online pages, and other data formats for communicating information over a network, such as the internet, a technical challenge exists for understanding and interpreting such unstructured data sources. Furthermore, this problem is exacerbated for systems that interact with a plurality of different systems each having their own unique unstructured data sources. Therefore, an improved technique for generating structured data from unstructured data is a technical challenge to be solved.

### BRIEF SUMMARY

Processes, apparatuses, machines, and articles of manufacture for verify entity state-quantity values for asynchronous operations are described. It will be appreciated that the embodiments may be combined in any number of ways without departing from the scope of this disclosure.

Example methods, such as computer-implemented methods generation of structured data for query execution are described herein. An example method may include: identifying, by a server computer system, a query requesting information regarding a client system; generating, with a first machine learning (ML) model executed by the server computer system, an embedding in vector space based on the query; identifying, by the server computer system, a similar embedding in the vector space and located in a vector store, wherein the vector store includes a plurality of embeddings generated based on data scraped from a website associated with the client system; retrieving, from a database, content associated with the similar embedding; generating, by the server computer system, a prompt based on the query and the content associated with the similar embedding; providing, by the server computer system, the prompt to a second ML model; identifying, by the server computer system, response data generated by the second ML model based on the prompt; and transforming, by the server computer system, the response data into structured data corresponding to the information requested regarding the client system.

Example server computer systems are disclosed herein. An example server computer system comprises a memory and a processor coupled to the memory configured to: identify a query requesting information regarding a client system; generate, with a first machine learning (ML) model, an embedding in vector space based on the query; identify a similar embedding in the vector space and located in a vector store, wherein the vector store includes a plurality of embeddings generated based on data scraped from a website associated with the client system; retrieve, from a database, content associated with the similar embedding; generating a prompt based on the query and the content associated with the similar embedding; provide the prompt to a second ML model; identify response data generated by the second ML model based on the prompt; and transform the response data into structured data corresponding to the information requested regarding the client system.

Example non-transitory computer-readable media are disclosed herein. An example non-transitory computer-readable storage medium includes instructions that, when executed by a processor, cause the processor to perform operations comprising: identifying, by a server computer system, a query requesting information regarding a client system; generating, with a first machine learning (ML) model executed by the server computer system, an embedding in vector space based on the query; identifying, by the server computer system, a similar embedding in the vector space and located in a vector store, wherein the vector store includes a plurality of embeddings generated based on data scraped from a website associated with the client system; retrieving, from a database, content associated with the similar embedding; generating, by the server computer system, a prompt based on the query and the content associated with the similar embedding; providing, by the server computer system, the prompt to a second ML model; identifying, by the server computer system, response data generated by the second ML model based on the prompt; and transforming, by the server computer system, the response data into structured data corresponding to the information requested regarding the client system.

Other processes, machines, and articles of manufacture are also described herein, which may be combined in any number of ways, such as with the embodiments of the brief summary, without departing from the scope of this disclosure.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 illustrates a block diagram of an exemplary system architecture for generating structured data from unstructured data according to some embodiments of the present disclosure.

FIG. 2 illustrates various aspects of a structured data generator according to some embodiments of the present disclosure.

FIG. 3 illustrates an exemplary process flow for generating embeddings for a vector store according to some embodiments of the present disclosure.

FIGS. 4A and 4B illustrate an exemplary process flow for identifying information to answer a query according to some embodiments of the present disclosure.

FIG. 5 illustrates a logic flow of an exemplary method for populating a vector store according to some embodiments of the present disclosure.

FIG. 6 illustrates a logic flow of an exemplary method for generating response data based on a query according to some embodiments of the present disclosure.

FIG. 7 illustrates a computer system that may be used to support the systems and operations discussed herein according to some embodiments of the present disclosure.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “identifying”, “determining”, “retrieving”, “engineering”, “generating”, “communicating”, “transforming”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

Generally, this disclosure describes techniques for transforming unstructured data into structured data in a manner that provides efficient and valuable insights. Existing techniques for transforming unstructured data into structured data are slow, inefficient, unreliable, and error prone. For example, existing techniques for structuring text usually involve manual tagging with metadata or part-of-speech tagging for further text mining-based structuring. However, manual tagging is a time-consuming and resource-intensive process. Further, manually tagging is prone to human error, reducing the reliability and accuracy of resulting structured data. Adding further complexity, the many and substantial variations between website structures is unclear and unpredictable making it difficult or impractical to reliably identify relevant content in an efficient and automated manner. These limitations can drastically reduce the reliability and adaptability of structured data generated from unstructured data, for example when attempting to gain insights from, and/or take actions that rely on, the unstructured data sources. Therefore, these challenges contribute to ineffective, error prone, and unpredictable analysis of such unstructured data sources, resulting in unreliable systems, devices, and techniques with limited capabilities.

Accordingly, many embodiments disclosed herein enable generating structured data, such as for client system intelligence, based on unstructured data in an efficient, valuable, automated, and intelligent manner. More specifically, embodiments are directed to computer-based techniques for collecting unstructured data, generating structured data based on the unstructured data, and integrating the structured data into existing systems that analyze and perform services based on the analysis results.

In many embodiments, unstructured data is collected from various sources, such as websites and systems that store and provide access to publicly available information. Content may be extracted from the unstructured data and then processed and stored in a manner to facilitate correlating the content with a query. For example, content may be embedded into a vector space, which is a collection of data elements that include a structured representation of the content extracted from the various sources. That is, for example, content collected from a website, such as a title, description, data from pages of interest, etc. may be extracted from a website and encoded into a vector space.

A query is then received, for example when a subject matter expert seeks information regarding which client systems would benefit from a specific strategy that requires an international presence of the client systems. The query may similarly be embedded into the vector space in order to identify content that is relevant to the query. A prompt for a machine learning (ML) model (e.g., a large language model (LLM)) may then be automatically generated based on the query and the relevant content. The prompt, for example, may include the query and the content that is relevant to the query.

The output of the ML model may then be validated and integrated into various downstream systems and subsystems, such as to recognize client system development opportunities and to take one or more actions, such as execute and/or configuring a service system based on the results of the ML model analysis (e.g., the structured data corresponding to information requested regarding the client system). For example, the query may ask whether a client system has engaged in fraudulent transactions. In some such examples, when the output of the ML model identifies the client system as having engaged in fraudulent requests, the account associated with the client system is suspended or placed on restrictions. In another example, the query may ask for a list of countries in which the client systems operate. In yet another example, a query may ask whether a client has any subscription services and the answer to the query may be utilized by a subsystem utilized to determine which clients to offer a subscription service to. In such examples, the answers to the query may be utilized to tune one or more systems that respond to client system requests, only seek to offer subscription services to the client systems that could benefit from them.

In these and other ways, components/techniques described herein provide many technical advantages. For instance, the computer-based techniques of the current disclosure enable websites with unclear and unpredictable structures to be utilized to derive useful and valuable structured data, such as for generating answers to queries, thereby improving the functioning of server systems as compared to conventional approaches. Additionally, the computer-based techniques of the current disclosure can provide users with a valuable tool for intelligently traversing content of a website to find a sought after piece of information in an efficient and automated manner. The computer-based techniques also provide durable and scalable indexing of contents from a variety of unstructured sources, such as websites. Further, the computer-based techniques provide accurate, dynamic, and adaptable retrieval strategies that utilize large sets of content with a wide variety of useful information. Further, systems function more efficiently with fewer processing errors and reduced remedial actions, such as by utilizing automation and validation. Accordingly, embodiments disclosed herein can be practically utilized to improve the functioning of a computer and/or to improve a variety of technical fields including data structuring, data indexing, data retrieval, data extraction, and/or data integration.

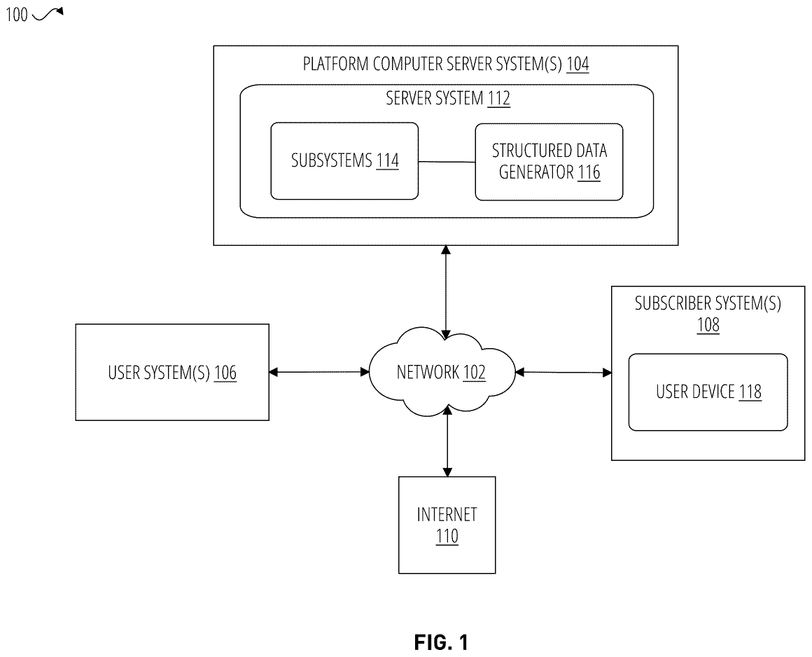

FIG. 1 is a block diagram of an exemplary system architecture 100 for generating structured data from unstructured data according to some embodiments. In one embodiment, the system 100 includes one or more platform computer server systems 104, one or more subscriber systems 108, one or more user systems 106, and. In one embodiment, one or more systems (e.g., systems 106 and 108) may be mobile computing devices, such as a smartphone, tablet computer, smartwatch, etc., as well computer systems, such as a desktop computer system, laptop computer system, server computer systems, etc. The platform computer server systems 104 and subscriber systems 108 may also be one or more computing devices, such as one or more server computer systems, desktop computer systems, etc. Furthermore, there may be any number of user systems 106 and/or subscriber systems 108 utilizing the services of the platform computer server systems 104. However, to avoid obscuring the present description, only one platform computer server system 104, user system 106, and subscriber system 108 are generally illustrated and described.

Furthermore, it should be appreciated that the embodiments discussed herein may be utilized by a plurality of different types of platform computer server systems, such as inventory platform system(s), media access and control system(s), resource platform system(s), card authorization platform system(s), payment processing platform system(s), gaming platform system(s), social media platform platform(s), and other systems. Then the platform computer server system 104 can include a plurality of service processing systems (not shown) that are distributed systems that perform the functions that provide the one or more services of the platform computer server system 104. Furthermore, any system seeking to generate structured data based on unstructured data may use and/or extend the techniques discussed herein to improve efficiency, scalability, and/or availability of structured data generated based on unstructured data. However, to avoid obscuring the embodiments discussed herein, structured data generation (e.g., via a structured data generator 116), is discussed to illustrate and describe the embodiments of the present invention, and is not intended to limit the application of the techniques described herein to other systems in which structured data generation could be used.

The platform computer server system 104, subscriber system 108, and user system 106 may be coupled to a network 102 and communicate with one another using any of the standard protocols for the exchange of information, including secure communication protocols. In some embodiments, the network 102 may facilitate access to the Internet 110 by one or more components, such as structured data generator 116. In one embodiment, one or more of the platform computer server system 104, subscriber system 108, and user system 106 may run on one Local Area Network (LAN) and may be incorporated into the same physical or logical system, or different physical or logical systems. Alternatively, the platform computer server system 104, subscriber system 108, and user system 106 may reside on different LANs, wide area networks, cellular telephone networks, etc. that may be coupled together via the Internet 110 but separated by firewalls, routers, and/or other network devices. In one embodiment, platform computer server system 104 may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc.

To generate structured data based on unstructured data in a uniform, scalable, and reliable manner, platform computer server system 104 may utilize a server system 112 including one or more subsystems 114 and/or a structured data generator 116. As will be discussed in greater detail below, the structured data generator 116 may collect content from various sources (such as a website on the Internet 110 and/or subsystems 114). Embeddings in a vector space may be generated based on the content and stored in a vector store. A query may be received, such as via subsystems 114. Embeddings in the vector space may be generated based on the query and utilized to identify relevant content corresponding to the query. The relevant content and the query may be utilized to generate a prompt for an ML model (e.g., an LLM). The output generated by the ML model based on the prompt may be validated and utilized to answer the query. The answer may be provided to one or more subsystems 114 for utilization in downstream operations, such as configuring or tuning one or more distributed service processing system(s) (not shown) of the platform server computer system 104, identifying client systems that would benefit from an additional capability, or determining client contact information. In some embodiments, the structured data generator 116 may receive input from and communicate output to a user device 118. In the illustrated embodiment, the user device 118 is included in the subscriber system 108. However, in additional, or alternative embodiment, the user device 118 may be included in user system 106 and/or platform computer server system 104 without departing from the scope of this disclosure. In some examples, the subsystems 114 and structured data generator 116 operate substantially independently from each other. For example, one or more embodiments described herein generally decouple generation of the vector store based on unstructured data from various sources (e.g., websites).

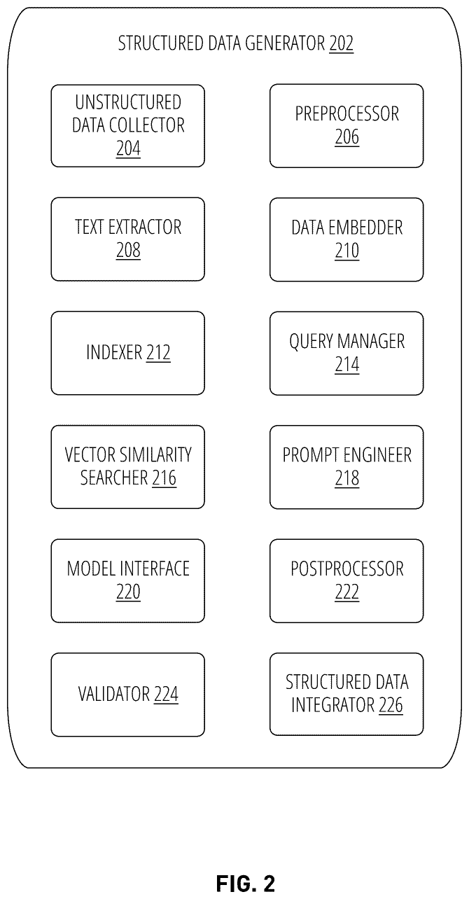

FIG. 2 illustrates various aspects of an exemplary structured data generator 202 according to some embodiments. The structured data generator 202 provides additional information for the structured data generator 116 discussed above. In the illustrated embodiment, the structured data generator 202 includes an unstructured data collector 204, a preprocessor 206, a text extractor 208, a data embedder 210, an indexer 212, a query manager 214, a vector similarity searcher 216, a prompt engineer 218, a model interface 220, a postprocessor 222, a validator 224, and a structured data integrator 226. In embodiments described hereby, the components of the structured data generator 202 may operate to enable intelligence on various client systems to be generated in an efficient and scalable manner, and actions to be taken in response thereto. The intelligence may be provided in the form of answers to queries posed to the structured data generator 202 regarding a client system. It will be appreciated that one or more components of FIG. 2 may be the same or similar to one or more other components disclosed herein. For example, structured data generator 202 may be the same or similar to structured data generator 116. Further, aspects discussed with respect to various components in FIG. 2 may be implemented by one or more other components from one or more other embodiments without departing from the scope of this disclosure. For example, preprocessor 206 and text extractor 208 may be included in unstructured data collector 204 without departing from the scope of this disclosure. In another example, model interface 220 may interact with a local ML model or a remote ML model (e.g., accessed via a network 102) without departing from the scope of this disclosure. Embodiments are not limited in this context.

In many embodiments, the structured data generator 202 enables generating structured data, such as for client system intelligence, based on unstructured data in an efficient, valuable, automated, and intelligent manner. For example, the components of structured data generator 202 may operate in conjunction to collect unstructured data, generate structured data based on the unstructured data, and integrate the structured data into existing systems and opportunities. It will be appreciated that the illustrated components of structured data generator 202 are exemplary and utilized to facilitate clear description of functional aspects of the structured data generator 202. However, various functionalities may be organized into a variety of functional modules without departing from the scope of this disclosure.

The unstructured data collector 204 may generally operate to obtain data and/or content regarding a client system from various sources, such as websites. In some embodiments, the unstructured data collector 204 may collect data regarding a client system from internal or private systems (e.g., subsystems 114). For example, the unstructured data collector 204 may identify one or more websites associated with a client system based on data included in a client account profile accessible via subsystems 114. In some embodiments, the unstructured data collector 204 may load a website and scrape content from the website, such as by generating content snapshots of the website. For example, the unstructured data collector 204 may scrape hypertext markup language (HTML) of a website. In many embodiments, the unstructured data collector 204 may generate HTML snapshots of websites associated with a client system.

In various embodiments, the unstructured data collector 204 may periodically obtain data and/or content regarding a client system from various sources, such as to ensure relevant and up to date content is available. For example, the unstructured data collector 204 may scrape a website at predefined intervals. In some embodiments, the predefined intervals may be different for different client systems. For example, client systems that exceed a threshold value of interactions with the platform computer server system 104 may be updated every month while client systems that are below a threshold value of interactions with the platform computer server system 104 may be updated every six months.

In many embodiments, the unstructured data collector 204 may determine whether content is different from previously scraped content. In many such embodiments, the unstructured data collector 204 may only trigger additional processing of the content when it is determined the content is new or updated, to reduce and/or eliminate unneeded expenditure of computation processing resources by the structured data generator 202. As discussed in more detail below, the additional processing can refer to additional steps taken to generate a vector store based on the content. For example, updating content may trigger rerunning one or more queries for a client system.

The preprocessor 206 may perform various manipulations on the content snapshots acquired by unstructured data collector 204 to generate cleaned content. For example, preprocessor 206 may remove scripts, advertisements, pop-ups, and the like from content snapshots generated by unstructured data collector 204. Next, the text extractor 208 may extract text from the cleaned content. In some embodiments, the text extractor 208 may generate content chunks based on the cleaned content. In some embodiments, each content chunk may correspond to a page, subpage, section, heading, subheading, text block, or the like. In many embodiments, the size of each content chunk may be based on token size that is utilized by the LLM. For example, content chunks may be 128 tokens, 256 tokens or 512 tokens.

The data embedder 210 may generate embeddings based on the content chunks. For example, data embedder 210 may embed or encode the content chunks into a vector space (as a vector), such as by using a ML model. Vector spaces are characterized by their dimensions, which may specify the number of independent directions in the space. In various embodiments, the vector space utilized for embeddings may have fifty or more dimensions, such as between 100 and 2500 dimensions. In some embodiments, the vector space may include 1536 dimensions. Each dimension may correspond to a characteristic of the content utilized to generate the embedding. Accordingly, similarities between different embeddings in the vector space are indicative of correlations between the content upon which the embeddings were generated.

The indexer 212 may organize and index the embeddings (also referred to as vectors) into a vector store. In some embodiments, the indexer 212 may operate to organize and structure the embeddings within a vector store in a manner that allows for fast and efficient retrieval of similar embeddings based on their proximity in the vector space. Further, each embedding may be associated or indexed according to the corresponding client system to enable searches for client specific data. These techniques can be utilized to enable quick similarity searches by mapping embeddings to specific locations within the data structure, making it efficient to find embeddings closely related to a given query vector. In some embodiments, one or more values for one or more dimensions in a vector may be utilized to index each embedding. In some embodiments, the corresponding content may be stored in a separate database, a portion of the database including the vector store, or within the vector store.

The query manager 214 may be utilized to determine queries and/or client systems that may benefit from a query. In some embodiments, the query manager 214 may provide a user interface that enables users to construct queries and/or sets of client systems corresponding to queries. In some embodiments, the query manager 214 may determine relevant queries or objectives for a defined set of client systems. In various embodiments, the query manager 214 may determine relevant client systems for a defined query or objective. For example, an objective may include identifying client systems that enable other client systems, such as how a food delivery service empowers restaurants. Accordingly, the query manager 214 may identify client systems that enable other client systems by determining which client systems utilize services of a platform computer server system 104 with companion services of the computer server system 104, such as delivery services that are companion to food purchase services.

The vector similarity searcher 216 may generate embeddings based on queries and utilize the embeddings to identify relevant content to the query. In some embodiments, the vector similarity searcher 216 may modify the queries prior to generating embeddings for the queries. For example, the vector similarity searcher 216 may remove punctuation and pronouns from a query before generating an embedding for the query. In some embodiments, the embeddings generated based on queries may be generated by the data embedder 210 instead of the vector similarity searcher 216. Once the embeddings have been generated, it may be utilized to identify similar embeddings in the vector store. The similar embeddings may be inferred to have relevant content for answering the query. In many embodiments, the relevant content corresponding to the similar embedding, along with the query, may be passed to the prompt engineer 218. The relevant content may be stored in a separate data base or the same data base as the vector store. In several embodiments, the content corresponding to a threshold number of most similar embeddings or the embeddings that meet a threshold similarity score may be passed to the prompt engineer 218.

The prompt engineer 218 may generate a prompt for a ML model, such as an LLM, based on the query and the relevant content. For example, the relevant content may be included in the prompt. In various embodiments, the prompt may include various instructions, such as tone, length, voice, format, context, and the like of the response. For example, the prompt may include instructions to provide the answer to a query based on the relevant contents included in the prompt. In some embodiments, the prompt engineer 218 may select a prompt template based on the query and/or relevant content. For example, a first prompt template may be utilized for true/false queries and a second prompt template may be utilized for open-ended questions.

The model interface 220 may then provide the prompt to the machine learning model to generate response data. In various embodiments, the model interface 220 may generate an application programming interface (API) request including the prompt and transmit the API request to the ML model, such as via a network. In one embodiment, the ML model may be a large language model. In various embodiments, the model interface 220 may analyze the prompt to determine a preferred ML model for generating a response to the query. The model interface 220 may also receive the response data from the ML model. For example, the model interface 220 may receive an API response including the response data.

The postprocessor 222 may extract the response data from the API response. In some embodiments, the postprocessor 222 may parse the response data into structured data. The validator 224 may perform one or more validation operations on the response data. For example, if the query requested an email address, the validator 224 may verify that the response data is a complete email address. In another example, if the query requested a phone number, the validator 224 may verify that the response data includes a properly formatted phone number. In yet another example, if a true/false query was posed, the validator 224 may verify that the response data includes true or false, but not true and false. The structured data integrator 226 may then pass the validated response data to appropriate downstream destinations. For example, a phone number and email address may be utilized to update a client system profile. In another example, an email address may be utilized to send a relevant communication to the client system. In one embodiment, the structured data integrator 226 may be utilized to perform additional validation operations, such as sending an email to a client system asking for confirmation that a phone number is accurate.

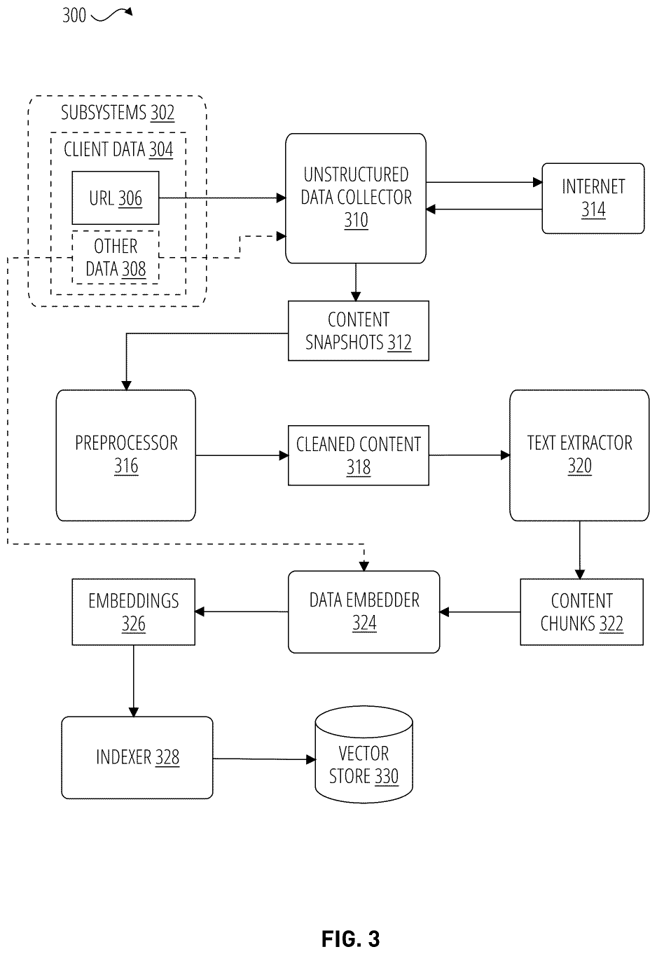

FIG. 3 illustrates a process flow 300 for a structured data generator according to some embodiments. For example, process flow 300 may support generating embeddings for a vector store 330 based on content obtained from various sources. In many embodiments, the process flow 300 may illustrate exemplary operations to generate a vector store that is utilized to efficiently and reliably identify relevant content corresponding to a query. The illustrated components of FIG. 3 include subsystems 302, unstructured data collector 310, internet 314, preprocessor 316, text extractor 320, data embedder 324, indexer 328, and the vector store 330. One or more components of FIG. 3 may be the same or similar to one or more other components disclosed hereby. For example, unstructured data collector 310 may be the same or similar to unstructured data collector 204. In another example, subsystems 302 may be the same or similar to subsystems 114. Further, aspects discussed with respect to various components in FIG. 3 may be implemented by one or more other components from one or more other embodiments without departing from the scope of this disclosure. For example, one or more aspects of process flow 300 may be implemented by other components of structured data generator 202 or server system 112 without departing from the scope of this disclosure. Embodiments are not limited in this context.

Referring to FIG. 3, process flow 300 may begin with identification of a URL 306 associated with a client system from which to scrape content. For example, this may be in response to creation of a new client in subsystems 302 or in response to a determination that the content previously scraped from the URL 306 should be checked for revisions and/or updates. In some embodiments, the determination that content should be checked for revisions and/or updates may be in response to the expiration of a predefined period of time (e.g., 14 days, 1 month, 6 months, etc.).

In some embodiments, the URL 306 may be included in client data 304 stored in subsystems 302. In many embodiments, the client data 304 may include information corresponding to a client system. For example, client data 304 (e.g., client system data) may correspond to a client profile stored in or by a subsystem of server system 112. In other embodiments, the URL 306 may be stored locally by the unstructured data collector 310 and/or provided via user input. In various embodiments, other data 308 may be additionally, or alternatively passed to the unstructured data collector 310. In some embodiments, the other data 308 may be processed in a similar manner to the URL. In some such embodiments, the similar manner may not include accessing the internet. For example, the other data 308 may include a picture of a business card from which text needs to be extracted. In other embodiments, as discussed in more detail below, one or more portions of the other data 308 may be passed directedly to the data embedder 324. In many embodiments, the URL 306 may identify a website associated with or generated by the client. In various embodiments, multiple URLs and/or pieces of other data may be processed to populate vector store 330.

Once the unstructured data collector 310 identifies the URL 306, it may access the contents of the URL 306, such as via the internet 314. In one embodiment, the URL 306 corresponds to a website for a business of the client system. The unstructured data collector 310 may generate various content snapshots 312 based on the website located at the URL 306. For example, the unstructured data collector 310 may generate snapshots of each page (including subpages) of the website. In many embodiments, the snapshots may include HTML snapshots. The content snapshots 312 may then be passed to the preprocessor 316. The preprocessor 316 may then generate cleaned content 318 based on the content snapshots 312. For example, the preprocessor 316 may remove scripts, pop-ups, links, and/or third-party content from the content snapshots 312 to produce cleaned content 318. The cleaned content 318 may then be passed to the text extractor 320.

The text extractor 320 may generate various content chunks 322 based on the cleaned content 318. For example, each content chunk may correspond to a page, subpage, section, heading, subheading, text block, or the like. In many embodiments, the size of each content chunk may be based on token size that is utilized by the LLM. For example, content chunks may be 128 tokens, 256 tokens or 512 tokens. In general, each content chunk should describe fewer rather than more different topics to improve the resulting embeddings.

The data embedder 324 may generate an embedding for each of the content chunks 322 into a vector space to produce embeddings 326. In various embodiments, the data embedder 324 may utilize an ML model, such as a bi-encoder or a bi-direction encoder. In some embodiments, the data embedder 324 may generate embeddings based on other data 308. The indexer 328 may index and store the embeddings into the vector store 330 in a manner that allows for efficient retrieval of similar embeddings based on their proximity in the vector space. Further, indexer 328 may index and store embeddings in association with the corresponding client system. Proximity of different embeddings in the vector store 330 provides an indication of similarity. In various embodiments, a feedback mechanism may be utilized to improve performance of the data embedder 324, such as based on rankings, by subject matter experts, of relevant content identified based on the embeddings.

Accordingly, as discussed in more detail below, embeddings of queries may be generated to identify content embeddings that include relevant content and most likely include the answer to the query. In these and other ways, components/techniques described herein provide many technical advantages. For instance, the computer-based techniques of the current disclosure enable websites with unclear and unpredictable structures to be utilized to derive useful and valuable structured data, such as for generating answers to queries, thereby improving the functioning of server systems as compared to conventional approaches. The computer-based techniques also provide durable and scalable indexing of contents from a variety of unstructured sources, such as websites. Further, systems function more efficiently with fewer processing errors and reduced remedial actions, such as by utilizing automation and validation.

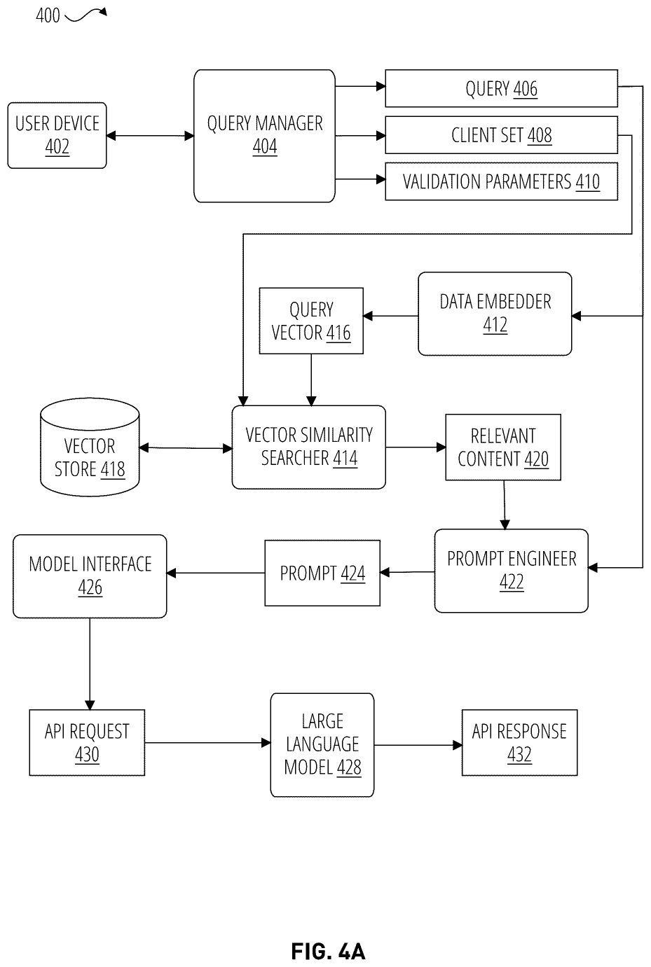

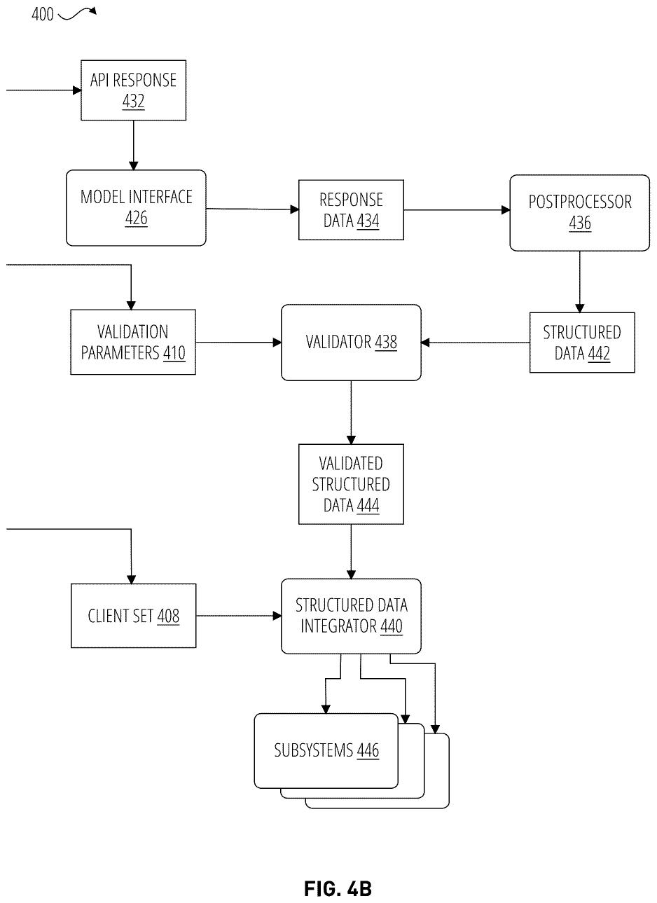

FIGS. 4A and 4B illustrate a process flow 400 for a structured data generator according to some embodiments. For example, process flow 400 may support identifying information to answer a query. In many embodiments, the process flow 400 may illustrate exemplary operations to intelligently traverse content of various data sources (e.g., websites) to find information to answer a query in an automated, reliable, and efficient manner. The illustrated components of FIGS. 4A and 4B include user device 402, query manager 404, data embedder 412, vector similarity searcher 414, vector store 418, prompt engineer 422, model interface 426, and large language model 428, postprocessor 436, validator 438, structured data integrator 440, and subsystems 446. One or more components of FIGS. 4A and 4B may be the same or similar to one or more other components disclosed hereby. For example, model interface 426 may be the same or similar to model interface 220. In another example, subsystems 446 may be the same or similar to subsystems 114. In yet another example, data embedder 412 may be the same or similar to data embedder 324. Further, aspects discussed with respect to various components in FIGS. 4A and 4B may be implemented by one or more other components from one or more other embodiments without departing from the scope of this disclosure. For example, one or more aspects of process flow 400 may be implemented by other components of structured data generator 202 or server system 112 without departing from the scope of this disclosure. Embodiments are not limited in this context.

Referring to FIG. 4A, process flow 400 may begin with identification of at least one of a query 406 and a client set 408 (e.g., a set of client systems) by query manager 404. In some embodiments, identification of the query 406 and/or the client set 408 by the query manager 404 may be based on input received from a user device 402. For example, a user interface flow may be generated by the query manager 404 for determining the query 406, the client set 408, and/or the validation parameters 410. In other embodiments, these parameters, or a portion of them, may be provided by one or more subsystems (e.g., one or more of subsystems 114). In some embodiments, one or more of the query 406, client set 408, and validation parameters 410 may be automatically determined, at least in part, based on the other parameters and/or data available in the system. In some embodiments, the client set 408 may be determined based on the query 406. For example, the query manager 404 may automatically identify a set of client systems that the system does not have an answer to the query. In various embodiments, the validation parameters 410, or at least a portion of them, may be determined based on the query 406. For example, if the query requests a phone number, a validation parameter that requires any answer to include a set of 10 numbers may be automatically created.

The query 406 may be provided to the data embedder 412. In some embodiments, query 406 may include multiple queries, such as related queries. For example, a first query may seek an email address while a second query may seek a phone number. The data embedder 412 may generate an embedding in the vector space based on the query (or each query) to produce query vector 416. In some embodiments, the data embedder 412 may modify the queries prior to generating embeddings for the queries, such as by removing punctuation and pronouns from a query before generating an embedding for the query. The query vector 416 may then be provided to the vector similarity searcher 414. Additionally, the client set 408 may be provided to the vector similarity searcher 414.

The vector similarity searcher 414 may search the vector store 418 to identify similar embeddings associated with each client system in the client set 408. The content related to the similar embeddings may then be provided to the prompt engineer 422 as relevant content 420. The query 406 may also be provided to the prompt engineer 422. In various embodiments, a feedback mechanism may be utilized to improve performance of the vector similarity searcher 414. For example, a subject matter expert may rank the relevant content 420 based on the query 406 and the rankings may be utilized to improve future performance of the vector similarity searcher 414.

The prompt engineer 422 may generate prompt 424 based on the relevant content 420 and the query 406. For example, the relevant content 420 and the query 406 may be included in the prompt. In many embodiments, different prompts may be generated for each client system in the client set so that only relevant content for each client system is identified as similar. In various embodiments, the prompt 424 may include various instructions, such as tone, length, voice, format, context, assign roles, and the like of the response. For example, the prompt may include instructions to provide the answer as a subject matter expert and in a specific format.

In some embodiments, the prompt engineer 422 may select a prompt template based on the query, the client set, and/or relevant content. For example, a first prompt template may be utilized for a first set of client systems (e.g., client systems that enable other client systems) while a second prompt template may be utilized for a second set of client systems (e.g., client systems that do not enable other client systems). In some embodiments, multiple queries may be included in prompt 424. In various embodiments, a feedback mechanism may be utilized to improve performance of the prompt engineer 422. For example, a subject matter expert may rank the prompt 424 based on the query 406 and/or the relevant content 420 and the rankings may be utilized to improve future performance of the prompt engineer 422.

In some embodiments, one or more prompts may be predefined and/or automatically submitted to the ML model (e.g., LLM 428) on a periodic basis. For example, new prompts may be generated and automatically submitted to the ML model in response to content being updated, such as by the unstructured data collector, text extractor, and/or data embedder. Among other things, this enables regular analysis of prompts and actions/configurations can be performed automatically (e.g., in response to answers that may change in response to changed website content).

The prompt 424 may then be provided to the model interface 426. The model interface 426 may generate an API request 430 including the prompt 424 and communicate the API request 430 to the large language model 428. The large language model 428 may then generate an API response 432 including response data to the query.

Referring to FIG. 4B, the API response 432 may be received by the model interface 426. The model interface 426 may extract response data 434 from the API response 432 and provide the postprocessor 436. The postprocessor 436 may generate structured data 442 based on the response data 434. For example, the postprocessor 436 may parse the response data 434 into structured data 442. The structured data 442 may then be provided to the validator 438 for validation. Additionally, the validation parameters 410 may be provided to the validator 438. The validator 438 may provide validated structured data 444 to the structured data integrator 440. The structured data integrator 440 may then persist the validated structured data 444 downstream for review/use, such as by subsystems 446. For example, subsystems 446 may utilize the validated structured data 444 for configuring or tuning one or more distributed service processing system(s) (not shown), identifying client systems that would benefit from an additional capability, or determining client contact information. The client set 408 may additionally be provided to the structured data integrator 440 and/or subsystems 446 to guide distribution of the validated structured data 444 to appropriate destinations. For example, the client set 408 may be utilized to determine account IDs to use to identify account profiles to update based on the validated structured data 444. In another example, the client set 408 may be utilized to determine contact information for client systems and the contact information may be utilized to send a communication asking for verification of the relevant validated structured data 444. In yet another example, during onboarding, a client set could extract a user's support email address (e.g. support@example-stripe-user.com) and then store this in a database. Later, another system/subsystem may load this value and use it to prefill a field during the onboarding process. In yet another example, determining whether or not a user sells alcohol may be determined and then stored in a database. During onboarding checks, this may be useful for determining whether products of a user can be supported or supported properly (e.g., age verification).

In these and other ways, components/techniques described herein provide many technical advantages. For example, the computer-based techniques of the current disclosure can provide users with a valuable tool for intelligently traversing content of a website to find a sought after piece of information in an efficient and automated manner. Further, the computer-based techniques provide accurate, dynamic, and adaptable retrieval strategies that utilize large sets of content with a wide variety of useful information. Furthermore, systems function more efficiently with fewer processing errors and reduced remedial actions, such as by utilizing automation and validation.

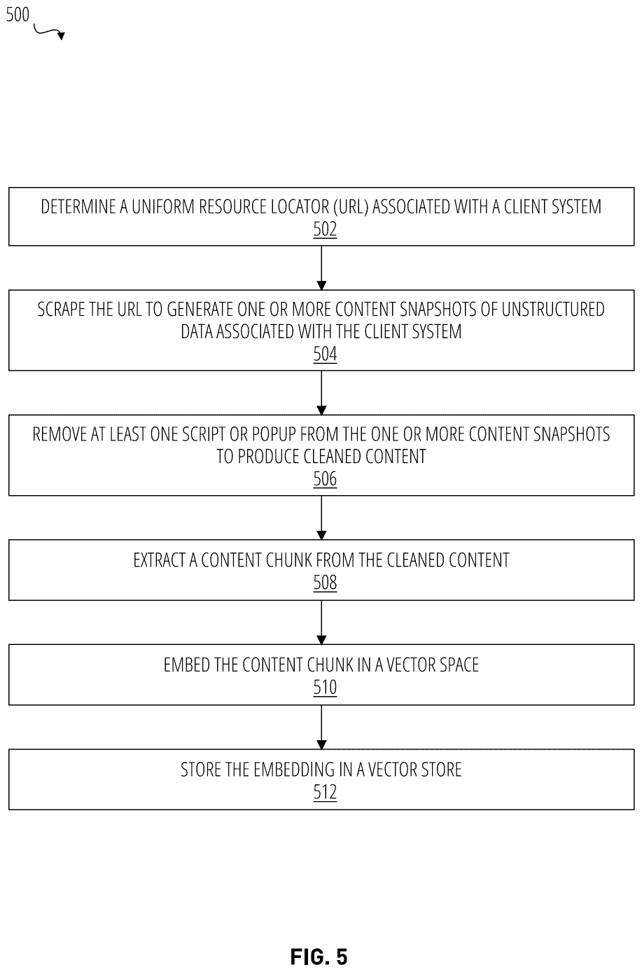

FIG. 5 illustrates a logic flow 500 of a method for populating a vector store according to some embodiments. The logic flow 500 is performed by processing logic that may comprise hardware (circuitry, dedicated logic, etc.), software (such as is run on a general purpose computer system or a dedicated machine), firmware, or a combination. In various embodiments, the logic flow 500 is performed by one or more of a platform system (e.g., platform computer server system 104), a server system (e.g., server system 112), and a structured data generator (e.g., structured data generator 116). Embodiments are not limited in this context.

Referring to FIG. 5, the logic flow 500 begins at block 502. At block 502, a URL associated with a client system may be determined. For example, unstructured data collector 310 may identify URL 306. In some embodiments, the URL 306 may identify a website of a client system or related to the client system. Proceeding to block 504, the URL may be scraped to generate one or more content snapshots of unstructured data associated with the client system. For example, unstructured data collector 310 may access the URL 306 via internet 314 and generate one or more content snapshots 312 of the unstructured data located at the URL 306. In some embodiments, the content snapshots 312 include HTML snapshots.

Continuing to block 506, at least one script or popup may be removed from the one or more content snapshots to produce cleaned content. For example, preprocessor 316 may remove scripts from content snapshots 312 to produce cleaned content 318. At block 508 a content chunk may be extracted from the cleaned content. For example, text extractor 320 may extract content chunks 322 from cleaned content 318. Proceeding to block 510, the content chunk may be embedded in a vector space. For example, data embedder 324 may generate a separate embeddings 326 for each of the content chunks 322. Continuing to block 512, the embedding may be stored in a vector store. For example, indexer 328 may index and store the embeddings 326 in vector store 330.

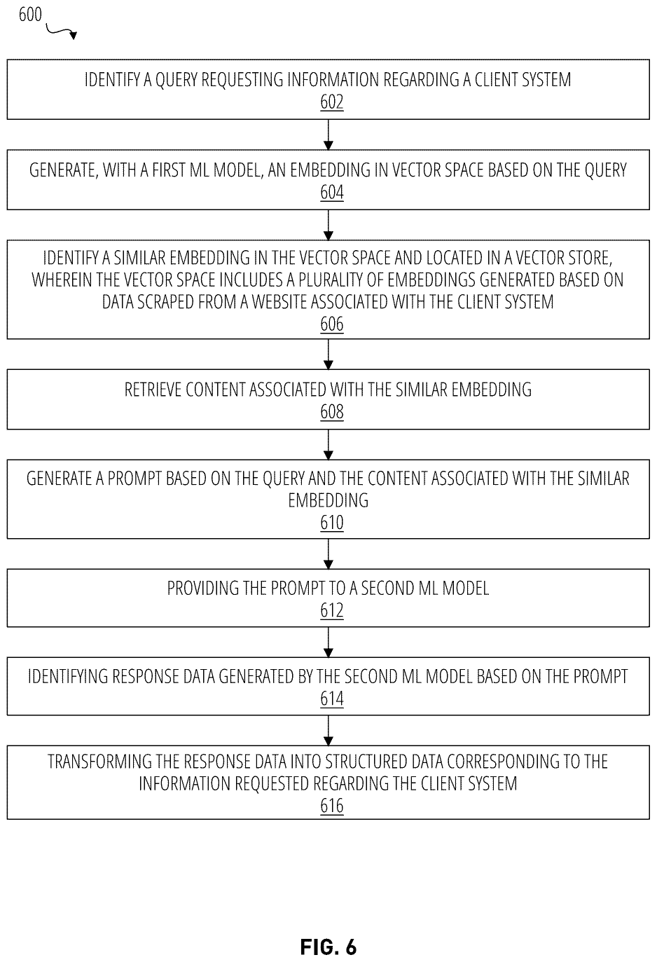

FIG. 6 illustrates a logic flow 600 of a method for generating response data based on a query according to some embodiments. The logic flow 600 is performed by processing logic that may comprise hardware (circuitry, dedicated logic, etc.), software (such as is run on a general purpose computer system or a dedicated machine), firmware, or a combination. In various embodiments, the logic flow 600 is performed by one or more of a platform system (e.g., platform computer server system 104), a server system (e.g., server system 112), and a structured data generator (e.g., structured data generator 116). Embodiments are not limited in this context.

Referring to FIG. 6, the logic flow 600 begins at block 602. At block 602, a query requesting information regarding a client system may be identified. For example, query manager 404 may identify query 406 requesting information regarding the client system in client set 408. Proceeding to block 604, an embedding in vector space may be generated with a first ML model. For example, data embedder 412 may generate query vector 416 with an embedding ML model, such as a bi-encoder. Continuing to block 606, similar embeddings in the vector space may be identified. Further the vector space may include a plurality of embeddings generated based on data scraped from a website associated with the client system. For example, vector similarity searcher 414 utilize vector store 418 to identify similar embeddings. Further, vector store 418 may include a plurality of embeddings generated based on data scraped from a website associated with the client system, such as a website located at URL 306.

Proceeding to block 608, content associated with the similar embedding may be retrieved. For example, vector similarity searcher 414 may retrieve the relevant content 420 associated with the similar embeddings. At block 610 a prompt may be engineered based on the query and the content associated with the similar embedding. For example, prompt 424 may be generated based on the relevant content 420 and the query 406. Continuing to block 612 the prompt may be provided to a second ML model. For example, model interface 426 may provide the prompt 424 to large language model 428. At block 614 response data generated by the second ML model based on the prompt may be identified. For example, model interface 426 may identify an API response 432 including response data generated by large language model 428. Proceeding to block 616 the response data may be transformed into structured data corresponding to the information requested regarding the client system. For example, postprocessor 436 may generate structured data 442 based on response data 434.

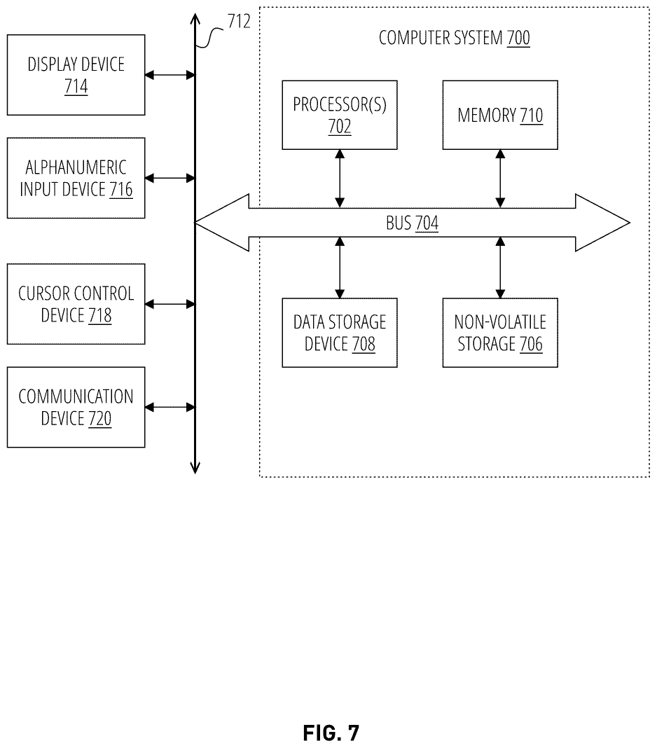

FIG. 7 is one embodiment of a computer system 700 that may be used to support the systems and operations discussed herein. For example, the computer system illustrated in FIG. 7 may be used by a platform server computer system, a server system, a user system, a structured data generator, one or more components thereof, etc. It will be apparent to those of ordinary skill in the art, however that other alternative systems of various system architectures may also be used.

The data processing system illustrated in FIG. 7 includes a bus or other internal communication means 704 for communicating information, and one or more processors 702 coupled to the bus 704 for processing information. The system further comprises a random access memory (RAM) or other volatile storage device (referred to as memory 710), coupled to bus 704 for storing information and instructions to be executed by processor 702. Memory 710 (e.g., main memory) also may be used for storing temporary variables or other intermediate information during execution of instructions by processor 702. The system also comprises non-volatile storage 706 (e.g., read only memory (ROM) and/or static storage device) coupled to bus 704 for storing static information and instructions for processor 702, and a data storage device 708 such as a magnetic disk or optical disk and its corresponding disk drive. Data storage device 708 is coupled to bus 704 for storing information and instructions.

The system may further be coupled to a display device 714, such as a light emitting diode (LED) display or a liquid crystal display (LCD) coupled to bus 704 through bus 712 for displaying information to a computer user. An alphanumeric input device 716, including alphanumeric and other keys, may also be coupled to bus 704 through bus 712 for communicating information and command selections to processor 702. An additional user input device is cursor control device 718, such as a touchpad, mouse, a trackball, stylus, or cursor direction keys coupled to bus 704 through bus 712 for communicating direction information and command selections to processor 702, and for controlling cursor movement on display device 714.

Another device, which may optionally be coupled to computer system 700, is a communication device 720 for accessing other nodes of a distributed system via a network. The communication device 720 may include any of a number of commercially available networking peripheral devices such as those used for coupling to an Ethernet, token ring, Internet, or wide area network. The communication device 720 may further be a null-modem connection, or any other mechanism that provides connectivity between the computer system 700 and the outside world. Note that any or all of the components of this system illustrated in FIG. 7 and associated hardware may be used in various embodiments as discussed herein.

It will be appreciated by those of ordinary skill in the art that a variety of configurations of the system may be used for various purposes according to the particular implementation. The control logic or software implementing the described embodiments can be stored in memory 710 (e.g., main memory), data storage device 708 (e.g., mass storage device), non-volatile storage 706 (e.g., ROM), or other storage medium locally or remotely accessible to processor 702.

It will be apparent to those of ordinary skill in the art that the system, method, and process described herein can be implemented as software stored in memory 710, non-volatile storage 706, and/or data storage device 708 and executed by processor 702. This control logic or software may also be resident on an article of manufacture comprising a computer readable medium having computer readable program code embodied therein and being readable by the data storage device 708 and for causing the processor 702 to operate in accordance with the methods and teachings herein.

The embodiments discussed herein may also be embodied in a handheld or portable device containing a subset of the computer hardware components described above. For example, the handheld device may be configured to contain only the bus 704, the processor 702, and memory 710 and/or non-volatile storage 706. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 702, a data storage device 708, a bus 704, and memory 710, and only rudimentary communications mechanisms, such as a small touch-screen that permits the user to communicate in a basic manner with the device. In general, the more special-purpose the device is, the fewer of the elements need be present for the device to function.

There are a number of example embodiments described herein.

Example 1 is a method for generation of structured data for query execution, the method comprising: identifying, by a server computer system, a query requesting information regarding a client system; generating, with a first machine learning (ML) model executed by the server computer system, an embedding in vector space based on the query; identifying, by the server computer system, a similar embedding in the vector space and located in a vector store, wherein the vector store includes a plurality of embeddings generated based on data scraped from a website associated with the client system; retrieving, from a database, content associated with the similar embedding; generating, by the server computer system, a prompt based on the query and the content associated with the similar embedding; providing, by the server computer system, the prompt to a second ML model; identifying, by the server computer system, response data generated by the second ML model based on the prompt; and transforming, by the server computer system, the response data into structured data corresponding to the information requested regarding the client system.

Example 2 is the method of Example 1 that may optionally include generating a plurality of content snapshots based on data obtained from scraping a website associated with the client system; and generating the plurality of embeddings in the vector store based on the plurality of content snapshots and the first ML model.

Example 3 is the method of Example 2 that may optionally include that generating the plurality of embeddings based on the plurality of content snapshots and the first ML model comprises: removing a script from at least one of the plurality of content snapshots to produce cleaned content; extracting a text chunk from the cleaned content; and providing the text chunk to the first ML model.

Example 4 is the method of Example 2 that may optionally include that each of the plurality of content snapshots comprises an HTML snapshot.

Example 5 is the method of Example 1 that may optionally include that providing the response to the second ML model comprises: generating an application program interface (API) request comprising the prompt; and communicating the API request to the second ML model.

Example 6 is the method of Example 5 that may optionally include that identifying the response data generated by the second ML model based on the prompt comprises receiving an API response corresponding to the API request.

Example 7 is the method of Example 1 that may optionally include that the first ML model comprises a bi-encoder or a bi-direction encoder.

Example 8 is the method of claim 1, that may optionally include updating a profile corresponding to the client system based on the structured data corresponding to the information requested regarding the client system.

Example 9 is the method of claim 1, that may optionally include configuring a service of the server computer system based on the structured data corresponding to the information requested regarding the client system.

Example 10 is a server computer system comprising a memory and a processor coupled to the memory configured to perform the method of any of Examples 1 to 9.

Example 11 is a non-transitory machine-readable medium having executable instructions to cause one or more processing units to perform the computer-implemented method of any of Examples 1 to 9.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A method for generation of structured data for query execution, the method comprising:
identifying, by a server computer system, a query requesting information regarding a client system;
generating, with a first machine learning (ML) model executed by the server computer system, an embedding in vector space based on the query;
identifying, by the server computer system, a similar embedding in the vector space and located in a vector store, wherein the vector store includes a plurality of embeddings generated based on data scraped from a website associated with the client system;
retrieving, from a database, content associated with the similar embedding;
generating, by the server computer system, a prompt based on the query and the content associated with the similar embedding;
providing, by the server computer system, the prompt to a second ML model;
identifying, by the server computer system, response data generated by the second ML model based on the prompt; and
transforming, by the server computer system, the response data into structured data corresponding to the information requested regarding the client system.

2. The method of claim 1, further comprising:
generating a plurality of content snapshots based on data obtained from scraping a website associated with the client system; and
generating the plurality of embeddings in the vector store based on the plurality of content snapshots and the first ML model.

3. The method of claim 2, wherein generating the plurality of embeddings based on the plurality of content snapshots and the first ML model comprises:
removing a script from at least one of the plurality of content snapshots to produce cleaned content;
extracting a text chunk from the cleaned content; and
providing the text chunk to the first ML model.

4. The method of claim 2, wherein each of the plurality of content snapshots comprises an HTML snapshot.

5. The method of claim 1, wherein providing the response to the second ML model comprises:
generating an application program interface (API) request comprising the prompt; and
communicating the API request to the second ML model.

6. The method of claim 5, wherein identifying the response data generated by the second ML model based on the prompt comprises receiving an API response corresponding to the API request.

7. The method of claim 1, wherein the first ML model comprises a bi-encoder or a bi-direction encoder.

8. The method of claim 1, further comprising updating a profile corresponding to the client system based on the structured data corresponding to the information requested regarding the client system.

9. The method of claim 1, further comprising configuring a service of the server computer system based on the structured data corresponding to the information requested regarding the client system.

10. A server computer system, comprising:
a memory; and
a processor coupled to the memory configured to:
identify a query requesting information regarding a client system;
generate, with a first machine learning (ML) model, an embedding in vector space based on the query;
identify a similar embedding in the vector space and located in a vector store, wherein the vector store includes a plurality of embeddings generated based on data scraped from a website associated with the client system;
retrieve, from a database, content associated with the similar embedding;
generating a prompt based on the query and the content associated with the similar embedding;
provide the prompt to a second ML model;
identify response data generated by the second ML model based on the prompt; and
transform the response data into structured data corresponding to the information requested regarding the client system.

11. The server computer system of claim 10, wherein the processor coupled to the memory is further configured to:
generate a plurality of content snapshots based on data obtained from scraping a website associated with the client system; and
generate the plurality of embeddings in the vector store based on the plurality of content snapshots and the first ML model.

12. The server computer system of claim 11, wherein to generate the plurality of embeddings based on the plurality of content snapshots and the first ML model the processor coupled to the memory is further configured to:
remove a script from at least one of the plurality of content snapshots to produce cleaned content;
extract a text chunk from the cleaned content; and
provide the text chunk to the first ML model.

13. The server computer system of claim 11, wherein each of the plurality of content snapshots comprises an HTML snapshot.

14. The server computer system of claim 10, wherein the processor coupled to the memory is further configured to update a profile corresponding to the client system based on the structured data corresponding to the information requested regarding the client system.

15. The server computer system of claim 10, wherein the processor coupled to the memory is further configured to configure a service system of the server computer system based on the structured data corresponding to the information requested regarding the client system.

16. A non-transitory computer readable storage medium including instructions that, when executed by a processor, cause the processor to perform operations, the operations comprising:
identifying, by a server computer system, a query requesting information regarding a client system;
generating, with a first machine learning (ML) model executed by the server computer system, an embedding in vector space based on the query;
identifying, by the server computer system, a similar embedding in the vector space and located in a vector store, wherein the vector store includes a plurality of embeddings generated based on data scraped from a website associated with the client system;
retrieving, from a database, content associated with the similar embedding;
generating, by the server computer system, a prompt based on the query and the content associated with the similar embedding;
providing, by the server computer system, the prompt to a second ML model;
identifying, by the server computer system, response data generated by the second ML model based on the prompt; and
transforming, by the server computer system, the response data into structured data corresponding to the information requested regarding the client system.

17. The non-transitory computer readable storage medium of claim 16, the operations further comprising:
generating a plurality of content snapshots based on data obtained from scraping a website associated with the client system; and
generating the plurality of embeddings in the vector store based on the plurality of content snapshots and the first ML model.

18. The non-transitory computer readable storage medium of claim 17, the operations to generate the plurality of embeddings based on the plurality of content snapshots and the first ML model further comprising:
removing a script from at least one of the plurality of content snapshots to produce cleaned content;
extracting a text chunk from the cleaned content; and
providing the text chunk to the first ML model.

19. The non-transitory computer readable storage medium of claim 16, the operations further comprising updating a profile corresponding to the client system based on the structured data corresponding to the information requested regarding the client system.

20. The non-transitory computer readable storage medium of claim 16, the operations further comprising configuring a service system of the server computer system based on the structured data corresponding to the information requested regarding the client system.
